(19) United States
(12) Patent Application Publication
(10) Pub. No.: US 2025/0256379 A1
(43) Pub. Date: Aug. 14, 2025

(54) Tension Wire Clamp Tool

(71) Applicant: Guadalupe Tamayo Comparan, San Diego, CA (US)

(72) Inventor: Guadalupe Tamayo Comparan, San Diego, CA (US)

(21) Appl. No.: 18/440,811

(22) Filed: Feb. 13, 2024

(51) Int. Cl. B25B 25/00

(52) U.S. Cl. CPC B25B 25/005

(57) ABSTRACT

The present invention is a tool for clamping a wire to a hose or cable. The tool is formed by a hollow housing unit to hollow for a rod to pass through and be moved forward by a spring assembly. The rod as a wire groove at the front that is sized to allow for wires of different sizes to fit inside. The spring assembly is activated by a user repeatedly engaging a trigger arm. Once a wire has been clamped onto a hose, a user simply has to press down on a tab at the back of the housing to release the rod and allow the user to manually push the rod back to its original position.

### FIELD OF THE INVENTION

This invention generally relates to tools for applying and securing clamps to a hose. More specifically, this invention is a tension wire clamp tool that uses a spring mechanism and tension to securely clamp a wire around a hose.

### BACKGROUND OF THE INVENTION

Many different tools have been used in attempt to simplify the process of applying clamps around a hose. One of the original hose-clamping solutions was done by wrapping wire with hose pliers such as what was disclosed in U.S. Pat. No. 699,349 and U.S. Pat. No. 2,600,394. While these tools were a step in the right direction, they were not without their own set of problems. Often times, a user had to perform multiple steps before being able to even use the tool, and even once they could use the tool, there was a risk that they could not generate enough leverage to effectively clamp the wire on the hose.

An alternative to the prior mentioned tools are specific clamp tools that were designed for use on hoses; commonly known as hose or worm clamps. These tools were designed in order to secure a specific type of wire clamp such as disclosed in U.S. Pat. No. 6, 164, 162 and U.S. Patent Publication No. 2004/0011161. The problem with these tools is that they are constructed specifically to apply either a hose or worm clamp and are expensive, and often designed for a preset size, thus limiting their ability to be used on hoses of varying size. In addition, they are also constructed with one use type in mind, so they are incompatible for use when a user wants to apply a different style of clamp onto a hose.

In consideration of the above, there is a need in the art for a wire clamping tool that is inexpensive and has near universal applicability.

### SUMMARY OF THE INVENTION

The present invention is a tension wire clamp tool that was designed to be low cost and universally applicable. To achieve this, the tension wire clamp tool has a rod that runs through a housing and protrudes out the face of the tool. This protrusion has a notch at the end that allows for a wire of any size to fit inside of it. On top of the housing there is a second rod that extends at an angle up and away from the housing and was designed so that the other end of the wire can be tied off, effectively anchoring the wire on one side. As a user engages the trigger handle, the spring mechanism pushes the rod forward, thus tightening the wire. To release the rod, all the user has to do is press down on the tab and manually push the rod back to its initial position.

Another benefit of the present invention is that it was designed to be a universal tool by being compatible with a wide number of different wire sizes that can be clamped onto a wide number of different pipes or hoses. This is due to a number of different features. The first is due to the notch at the end of the rod that protrudes from the housing of the tool and is sized to accommodate wires of all different sizes. The second is that the housing unit itself has scores, that start wide at the top and become narrower at the bottom of the housing, to serve as guides for the wire. Finally, since the rod only needs to engage the wire that is wrapped around the pipe prior to use, the tension wire clamp tool can be used on pipes of varying diameter. These features allow for a low-cost tool that can be used in a wide variety of different settings and on a wide variety of applications.

### BRIEF DESCRIPTION OF THE DRAWINGS

The novel features of the current invention are best exemplified by drawings of embodiments in conjunction with the following description, in which similarly-referenced characters refer to similarly-referenced parts, and in which:

FIG. 1 is a side view of the tension wire clamp tool for tightening a wire clamp around a hose;

FIG. 2 is a cutaway view of the tension wire clamp tool in which the spring mechanism of the tension wire clamp tool is visible to show the push spring around the rod and against the push wall actuated by the trigger arm;

FIG. 3 is a top view of the tension wire clamp tool showing the housing and the rod passing through the housing and having a rod groove to receive a clamping wire;

FIG. 4 is a front view of the tension wire clamp tool showing the rod and rod groove;

FIG. 5 is a side close-up view of the release mechanism of the tension wire clamp tool to release the rod once a wire claim is tightly placed around a hose or pipe;

FIG. 6 is a side view of the tension wire clamp tool with the trigger arm partially compressed as used to install a wire clamp;

FIG. 7 is a side view of the tension wire clamp tool with the trigger arm fully compressed to urge the rod through the housing to tighten the wire clamp;

FIG. 8 is a close-up view of the tension wire clamp tool with the groove of the rod situated on a wire on a hose with one end of the wire clamp in the rod groove of the rod, and the other end of the wire clamp on the post;

FIG. 9 is a side elevational view of the tension wire clamp tool being used with a wire on a hose when the wire is seated in the rod groove and wrapped around the post;

FIG. 10 is a side elevational view of the tension wire clamp tool being used to install a wire clamp on a hose and the trigger arm being actuated;

FIG. 11a is a wire with a closed loop;

FIG. 11b is a wire with a bight and two free ends;

FIG. 11c is the wire of FIG. 11b showing the free ends twisted together to create a wire loop having a particular length to accommodate the hose or pipe being clamped;

FIG. 12 shows a wire that is looped through the bight end; and

FIG. 13 is a block diagram depicting the steps to accomplish the method of the present invention according to several embodiments.

### DETAILED DESCRIPTION

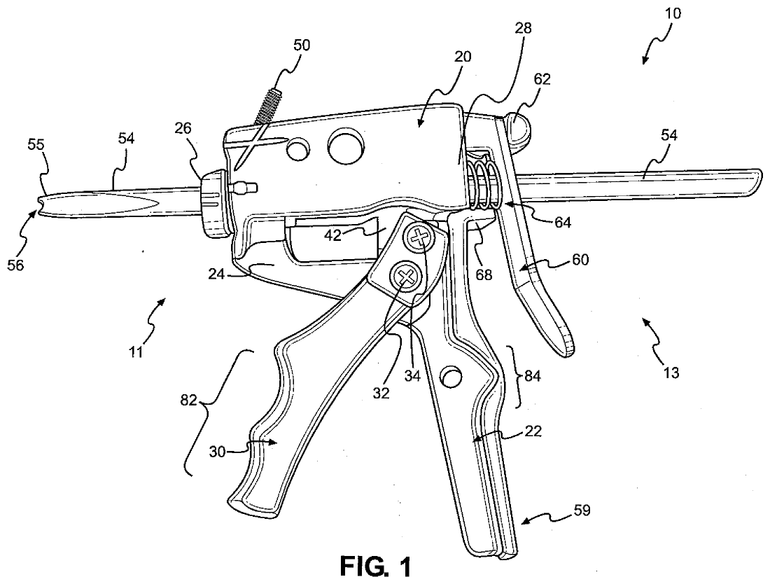

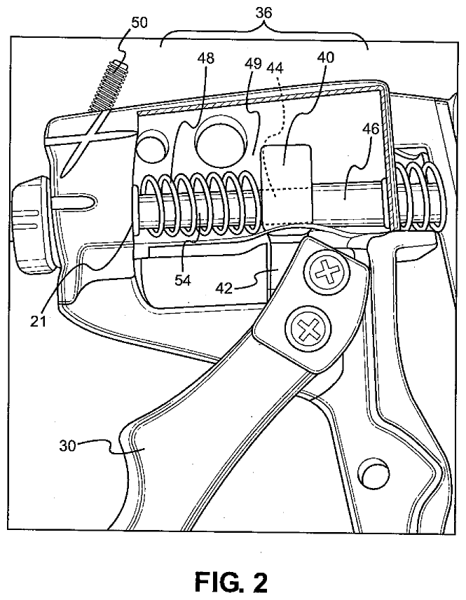

Referring now to FIG. 1, a side view of tension wire clamp tool 10 is shown. Housing 20 and housing handle 22 form one piece. Housing 20 is a hollowed out rectangular shape that has an open top and bottom so that rod 54 and spring assembly 36 (see FIG. 2) are visible, while housing handle 22 extends vertically downward from the back end of housing 20. It is fully envisioned that in other embodiments that the top and bottom ends of housing 20 are closed off. On the front end 11 of tension wire clamp tool 10, housing 20 is also constructed with a housing bridge 24 that connects the front end of housing 20 to housing arm 59. The housing arm 59 includes a convexity 84 to provide additional grip comfort for a user.

Trigger arm 30 is attached to the housing 20 by housing stud 32 and trigger stud 34. Both of these studs are screwed in on one side of the top of housing handle 22 and secured by a nut (not shown) on the opposite side of housing 20. Using this method of attachment allows trigger arm 30 to rotate freely about housing stud 32 in a bidirectional way; depending on whether a user compresses trigger arm 30 or releases it back to its resting position. The open position is when the trigger arm 30 is the farthest from the housing arm 22 as currently shown in FIG. 1. Trigger arm can also be designed to include divots 82 which will provide additional grip support for a user while also increasing the comfort of trigger handle 30.

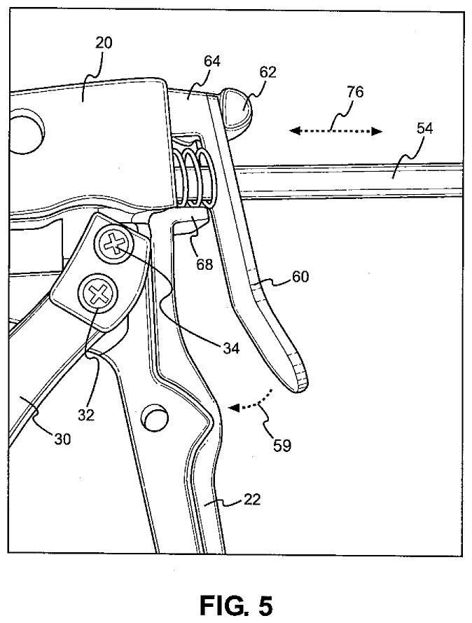

Rod 54 extends all the way through both the front and back end of housing 20 entering at front aperture 26 and exiting at aft aperture 28. The front end 55 of rod 54 has a wire groove 56 which is sized to accommodate wires of different sizes. The portion of rod 54 that runs through housing 20, is encased by spring assembly 36 (shown in FIG. 2) before it extends out the back end of housing 20. Once rod 54 is outside of housing 20, it passes through release spring 64 and release handle 60 on the back end 13 of tension wire clamp tool 10. The purpose of release handle 60 is to allow a user to compress it in direction 80 (shown in FIG. 5) and slide rod 54 back to its starting position after successfully clamping on a wire. Spring assembly 36 (see FIG. 2) is what provides the axial force to rod 54 so that it tightens the wire when a user compresses trigger handle 30. Every time a user compresses trigger handle 30, rod 54 is prevented from moving back to its original position by latch stop 68, which does not release rod 54 until release tab 60 is compressed in direction 80 by a user.

Referring now to FIG. 2, a cutaway view of housing 20 is shown to better illustrate the different components that make up spring assembly 36, which is made up of push spring 48, push wall 40, and push wall stopper 46. Push spring 48 is coiled around rod 54 and extends from the inner front end 21 of housing 20 to the push wall 40. Push wall 40 is positioned at the back end 49 of push spring 48 and has push wall aperture 44, illustrated by the dotted line, that rod 54 runs through.

In a preferred embodiment, push wall 40 is a rectangular shape that is larger than the diameter of the push spring 48 so that push wall 40 compresses spring 48 when a user squeezes trigger arm 30. However, it is fully envisioned that push wall 40 can come in a variety of different shapes, such as a circle. Push wall 40 has a foot 42 that extends from push wall 40 and is secured to trigger arm 30 by trigger stud 34. On the opposite side of push wall 40 from back end 49 is push wall stopper 46, which prevents push wall 40 and trigger arm 30 from moving too far in the wrong direction when trigger handle 30 is no longer engaged by a user. In this embodiment, push wall stopper 46 is cylindrically shaped and encases rod 54; however, it is full envisioned that push wall stopper 46 can be any other shape that performs substantially the same way.

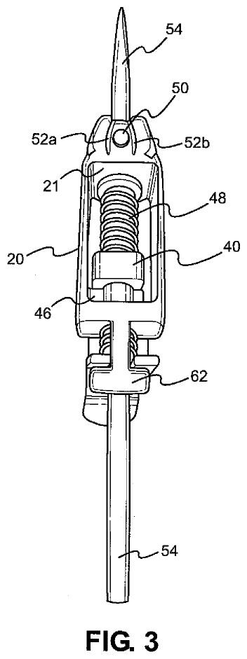

Referring now to FIG. 3, a top view of tension wire clamp tool 10 prior to using wire 14 is shown. In this embodiment, the top of tension wire clamp tool 10 is open so that a user can easily view the entirety of spring assembly 36. This view also clearly shows rod 54 running the entire length of tension wire clamp tool 10 and protruding out of either end of the tension wire clamp tool. At the front end tension wire clamp tool 10, post 50, first score 52a, and second score 52b are shown; while at the back end curb 62 is shown.

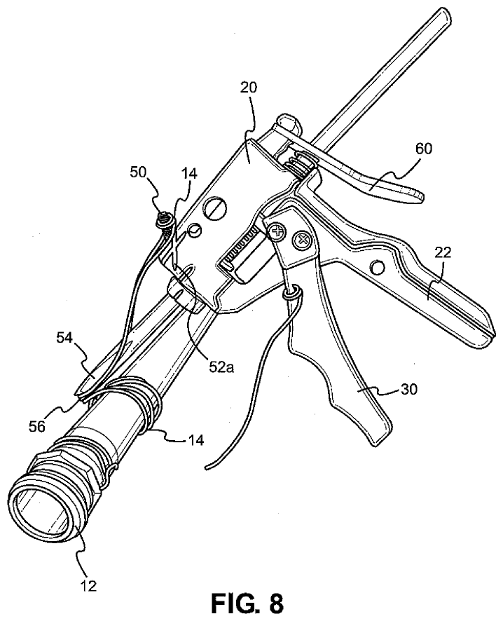

Post 50 that is a threaded rod that protrudes at a predetermined angle away from the top of housing 20. The angle and threading of post 50 is what helps temporarily anchor wire 14 (shown in FIG. 8) while it is being clamped around a hose 12 (shown in FIG. 8). It is fully envisioned that post 50 can be fully vertical, at different angles, or be a rod without threading.

On either side of post 50 is first score 52a and second score 52b. These two scores act as tracks that guide the wire from post 50 to rod 54, specifically to wire groove 56 on frond end 55 of rod 54. Both first score 52a and second score 52b are tapered so that the top of the score is wider than the bottom. This feature will allow a user to use a wide variety of different wires that come in different sizes and thickness due to this design feature of tension wire clamp tool 10.

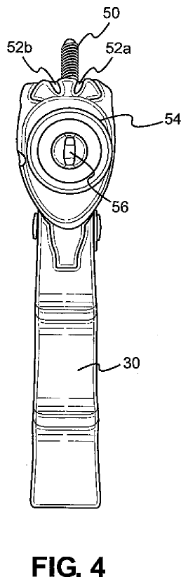

Referring now to FIG. 4, a front view of tension wire clamp tool 10 is shown. This view better illustrates the shape of first score 52a and second score 52b. Post 50 is also shown extending at an angle away from the front end 11 (compare to FIG. 1) of tension wire clamp tool 10. Another important feature of this view is that wire groove 56 at the front end of rod 54 is shown. Wire groove 56 runs vertically so that wire 14 (see FIG. 8), which runs perpendicular to wire groove 56, can neatly fit inside and be secured in groove 56 while a user is clamping wire 14 onto hose 12 (see FIG. 8).

Referring now to FIG. 5, a side view of the back end 13 (compare to FIG. 1) of tension wire clamp tool 10 is shown. Specifically, release tab 60, release spring 64, and curb 62 are shown, and they are what allow a user to release rod 54 once wire 14 (see FIG. 8) is fully clamped onto hose 12 (see FIG. 8). As a user repeatedly engages trigger handle 30, rod 54 will advance along direction 76. However, once wire 14 (see FIG. 8) is securely clamped on a hose or pipe 12 (see FIG. 8), a user can release rod 54 by compressing release tab 60 so that is moves along direction 80. Specifically, as release tab 60 rotates along direction 80, curb 62 anchors the upper end of release tab 60 to compress spring 64 to decrease contact between rod 54 and release tab 60, which in turn, allows a user to move rod 54 along direction 76 back into its original position.

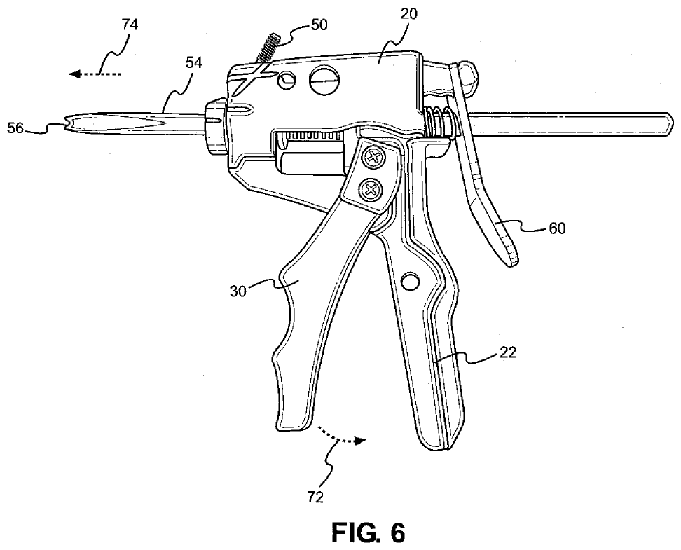

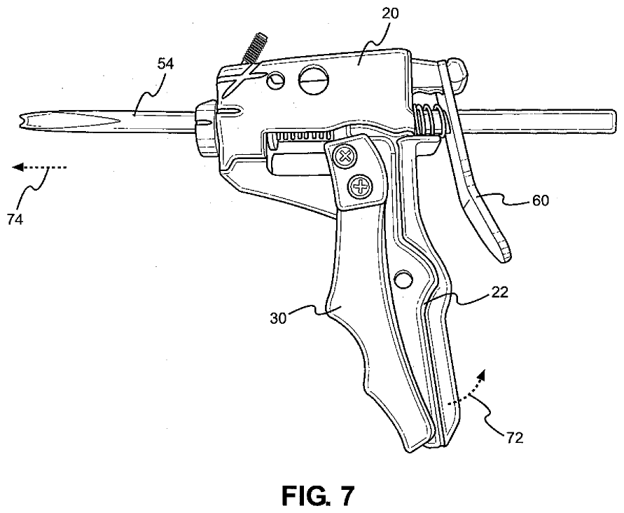

Referring now to FIGS. 6 and 7, tension wire clamp tool 10 is shown in the open and closed position respectively. In FIG. 6, tool 10 is shown in the “open” position that has rod 54 in its initial retracted position as well as trigger handle 30 in its resting position as well. When a user starts to use tension wire clamp tool 10, they will grip both trigger handle 30 and housing arm 22. Trigger handle 30, when compressed by a user, will move along direction 72 and this movement will force rod 54 to move along direction 74. FIG. 7 shows trigger arm 30 fully compressed and touching housing arm 22. Once a user stops applying a compressive force and releases trigger arm 30, it will return to the initial position shown in FIG. 6. As a user repeatedly engages and disengages trigger arm 30, rod 54 will continue to move along direction 74 until wire 14 tightens between groove 56 and post 50 and is firmly secured onto hose 12.

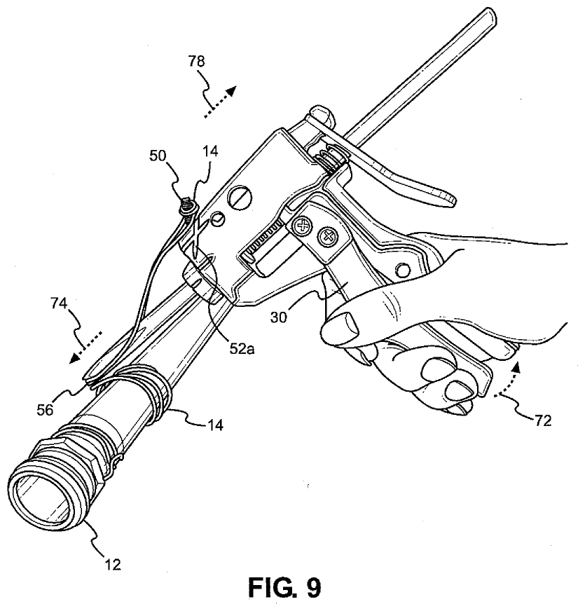

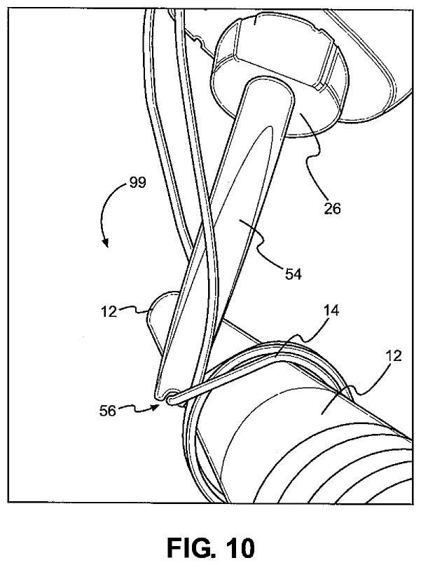

Referring now to FIGS. 8-10, tension wire clamp tool 10 is shown in the open and closed position to illustrate the process of wire 14 being clamped onto hose 12. In FIG. 8, wire 14 is shown positioned in wire groove 56. Wire 14 is also shown encircling hose 12 and wrapped around post 50, so that wire 14 is anchored at one side while a user clamps the other side down. As wire 14 becomes tight, wire 14 will sit further into scores 52 to prevent wire 14 from moving or slipping on housing 20 as more tension is created. The user can then repeatedly squeeze trigger arm 30 in order to move rod 54 forward in direction 74 until the user has reached a desired level of tautness in wire 14 as shown in FIG. 9. In FIG. 10, a close-up view of wire 14 being clamped onto hose 12 is shown. Once wire 14 is sufficiently tight, tool 10 is rotated in direction 99 to create an angle in wire 14 where it passes through loop 92 to prevent the wire clamp from releasing its tension around the hose or pipe.

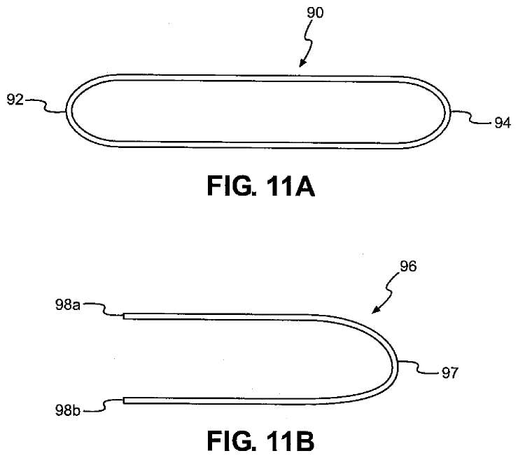

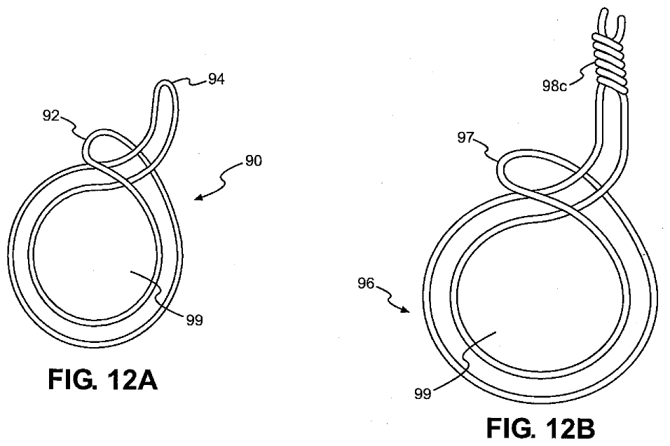

Referring now to FIGS. 11 and 12, the different wires and how they can be looped around a hose 12 prior to being clamped down are shown. It is fully envisioned that many different types of wire can be used in conjunction with tension wire clamp tool 10. One type of wire clamp, as shown in FIG. 11a, is closed loop wire 90 having a first loop end 92 for positioning in groove 56, and a second loop end 94 for positioning over post 50. It is to be appreciated that loop wire can have any length necessary to encircle a pipe, hose, cable, or any other item in which a tight circular band would secure.

FIG. 11b shows an alternative embodiment of an open-ended wire 96 that has a bight 97 and two free ends 98a and 98b. The two free ends 98a and 98b can be twisted together as 98c (shown in FIG. 12b) to create a loop of a desired size.

FIG. 12a illustrates the process of pre-installing a loop wire 90 onto a hose 12. The first end 92 is positioned into wire groove 56 of rod 54 (see FIGS. 8-9) and second end encircles the hose and extend between the groove 56 and the post 50 (see FIGS. 8-9). Loop wires 90 can come in different sizes to accommodate clamping hoses, pipes or cables having differing diameters.

FIG. 12b shows how an open-ended wire 96 is installed onto a hose 12. The two free ends 98a and 98b are strung below the bight end such that a loop 99 is formed over a hose 12. The bight end 97 is positioned into wire groove 56 of rod 54 (see FIGS. 8-9) and free ends 98a and 98b are twisted 98c to form a wire clamp of the desired length to encircle the hose and extend between the groove 56 and the post 50 (see FIGS. 8-9).

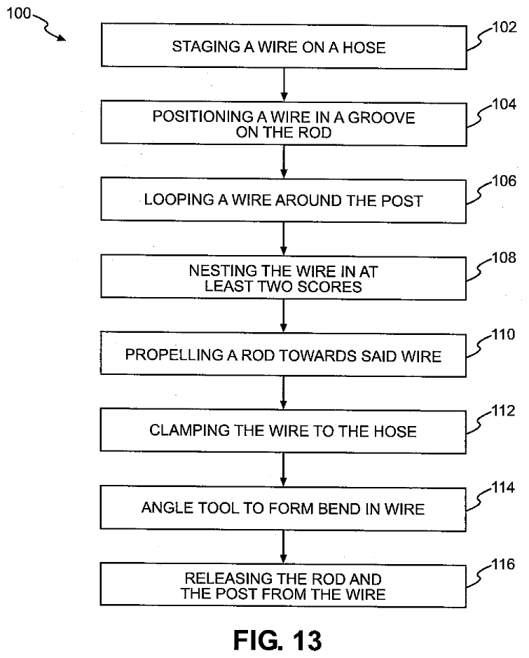

Referring now to FIG. 13, a flow diagram detailing the steps for a user to follow when using tension wire clamp tool 10 is shown, and generally designated process 100. At step 102, a user will stage wire 14 onto hose 12 by wrapping wire 14 around hose 12 as described above. Next, in step 104, the user will position wire 14 into wire groove 56 on rod 54 and then immediately proceed to step 106, and loop wire 14 around post 50 so that wire 14 encircles hose 12. Next, the user will move to step 108 and nest wire 14 into scores 52a and 52b. Then at step 110 a user will begin repeatedly engaging trigger arm 30 so that rod 54 is propelled forward to create tension in wire 14 to securely clamp wire 14 onto hose 12 at step 112. Once the user has determined that an appropriate level of tension has been reached, then the user will move to the last step at step 114 and angle tool 10 to form a bend in wire 14 to secure wire 14 around hose 12. Finally, in step 116, the user releases rod 54 and remove wire 14 from groove 56 of rod 54 and post 50.

While what has been shown is presently considered to be the preferred embodiments of the present invention, it will be apparent to those skilled in the art that various changes and modifications can be made herein without departing from the scope and spirit of the invention.

What is claimed is:

1. A tension wire clamp tool comprising:
a hollow housing unit that has a top side, a bottom side, a front end, and a back end;
a housing arm that extends down from said bottom side of said housing unit;
a spring assembly that is installed within said housing unit;
a trigger arm that is pivotally connected to the top of said housing arm wherein said trigger arm is also connected to said spring assembly,
a rod that runs through both said proximal end and said distal end of said housing;
a tab mounted on the distal end of said housing unit; and
a post that is mounted onto said top side of said housing unit.

2. The tension wire clamp of claim 1, wherein said rod has a groove at the front end that is sized to receive wires of different sizes.

3. The tension wire clamp of claim 2, wherein said housing unit has scores on the right side and left side of said housing unit.

4. The tension wire clamp of claim 3, wherein said post is set at a predetermined angle.

5. The tension wire clamp of claim 4, wherein the spring assembly further comprises a push spring, and a push wall.

6. The tension wire clamp of claim 5, wherein the tab further comprises a release spring and a curb located on the top of said tab.

7. A method for clamping a wire, said method comprising the steps of:
staging a wire on a hose;
seating said wire in a groove, said groove being formed on a rod wherein said rod extends through a housing;
looping said wire around a post, said post being embedded in said housing;
nesting said wire in at least two scores, said at least two scores formed on said housing;
propelling said rod toward said wire by actuating a trigger arm wherein said trigger arm is connected to said housing;
clamping said wire to said hose; and
releasing said rod and said post from said wire.

8. The method for clamping a wire of claim 7, wherein said clamping step is accomplished by repeatedly actuating said trigger arm until said wire is taut.

9. The method for clamping a wire of claim 7, wherein said looping step is engaged by wrapping at least one end of a two-end wire around said post.

10. The method for clamping a wire of claim 7, wherein said looping step is accomplished by placing one end of a closed loop wire around said post.

11. The method for clamping a wire of claim 7, wherein said propelling step is accomplished by compressing a spring against said housing wall with said trigger arm.

12. The method for clamping a wire of claim 7, wherein said releasing step is accomplished by pressing on a latch to permit the rod to slide freely through the housing, said latch being connected to said housing.
